(19) United States
(12) Patent Application Publication
(10) Pub. No.: US 2004/0062921 A1
(43) Pub. Date: Apr. 1, 2004

(54) Nacreous polyester sheet

(75) Inventors: Thomas M. Laney, Spencerport, NY (US); Peter T. Aylward, Hilton, NY (US); Robert P. Bourdelais, Pittsford, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/255,922

(22) Filed: Sep. 26, 2002

(51) Int. Cl. B29C 65/00; B32B 3/26; B32B 3/00

(52) U.S. Cl. 428/304.4; 428/314.2; 264/41

(57) ABSTRACT

The invention relates to a nacreous polymer sheet comprising voided polyester polymer wherein said sheet has voids of a length to height ratio of greater than 9:1, voids of a length of between 10 and 100 micrometer and a number of voids in the vertical direction is greater than 6.

### FIELD OF THE INVENTION

This invention relates to imaging materials. In a preferred form, it relates to base materials for photographic reflective paper.

### BACKGROUND OF THE INVENTION

It has been proposed in U.S. Pat. No. 5,866,282 (Bourdelais et al.) to utilize a composite support material with laminated biaxially oriented polyolefin sheets as a photographic imaging material. In U.S. Pat. No. 5,866,282, biaxially oriented polyolefin sheets are extrusion laminated to cellulose paper to create a support for silver halide imaging layers. The biaxially oriented sheets described in U.S. Pat. No. 5,866,282 have a microvoided layer in combination with coextruded layers that contain white pigments such as TiO₂ above and below the microvoided layer. The composite imaging support structure described in U.S. Pat. No. 5,866,282 has been found to be more durable, sharper and brighter than prior art photographic paper imaging supports that use cast melt extruded polyethylene layers coated on cellulose paper.

A photographic element with a microvoided sheet of opalescence is described in U.S. Pat. No. 5,888,681 (Gula et al.). In U.S. Pat. No. 5,888,681 microvoided polymer sheets with microvoided polymer layer located between a cellulose paper base and developed silver halide imaging provide an image with a opalescence appearance. While the opalescence appearance is present in the image, the image suffers from a loss of image sharpness or acutance, a higher density minimum position and a decrease in printing speed compared to typical a photographic image on a white, reflecting base. It would be desirable if the desirable opalescent look of the image could be maintained while improving printing speed, increasing sharpness and decreasing density minimum.

In U.S. Pat. No. 6,274,284, an imaging element with a nacreous appearance is disclosed. Biaxially oriented polypropylene sheet containing air voids are used to create multiple reflection planes for incident light to provide the image layer with a nacreous or opalescent appearance. While the voided polypropylene layer in U.S. Pat. No. 6,274,284 does provide a nacreous or opalescent image, the degree of opalescence is lower than what would be preferred for some applications, in particular advertisements. Because the voids aspect ratio (length to height ratio) disclosed in U.S. Pat. No. 6,274,284 is less than 8, the level of opalescence is less than preferred. It would be desirable for a voided layer to have an aspect ratio greater than 9 to increase the nacreous look or opalescence to a more desirable level.

Prior art reflective photographic papers contain white pigments in the support just below the silver halide imaging layers to obtain image whiteness and sharpness during image exposure as the white pigment reduces the amount exposure light energy scattered by cellulose paper core. Details on the use of white pigments in highly loaded coextruded layers to obtain silver halide image sharpness and whiteness is recorded in U.S. Pat. No. 5,466,519.

### PROBLEM TO BE SOLVED BY THE INVENTION

There is a need for a reflective imaging material that provides greater opalescence or nacreous look while, at the same time, maintains photographic sharpness or printing speed and whiter in appearance to the viewer.

### SUMMARY OF THE INVENTION

It is an object of the invention to provide improved imaging materials it is another object to provide photographic reflective materials that have very high opalescence or nacreous look.

It is a further object to provide improved image sharpness and printing speed compared to prior art voided base photographic materials.

These and other objects of the invention are accomplished by a nacreous polymer sheet comprising voided polyester polymer wherein said sheet has voids of a length to height ratio of greater than 9:1, voids of a length of between 5 and 100 micrometer and a number of voids in the vertical direction of greater than 6.

### ADVANTAGEOUS EFFECT OF THE INVENTION

The invention provides brighter, snappy images by maximizing the nacreous look while, at the same time, providing images that have exceptional photographic sharpness and exposure speed.

### DETAILED DESCRIPTION OF THE INVENTION

The invention has numerous advantages over prior art photographic reflective materials. The reflective materials of the invention provide an image with a nacreous appearance while maintaining efficient reflection of light, sharpness and photographic speed. Maintaining image sharpness and whiteness is important as consumers expect silver halide images to be high in quality. Further, maintaining printing speed is critical for efficient photographic processing as a significant loss in printer speed could increase the cost of consumer silver halide images. The optical properties of the imaging materials in accordance with the invention are improved as the tinting and optical brightening materials can be concentrated in a layer of the biaxially oriented polymer sheet for most effective use with little waste of the colorant materials.

The nacreous imaging materials of the invention provide a eye catching appearance that make them particularly desirable in imaging applications that require obtaining the attention of the consumer. One example includes display materials that are intended to communicate an advertising message to people in a public setting such as a bus stop, train station or airport. The highly nacreous images are differentiated in look from prior art materials and thus provide the pop and sizzle that can catch consumers attention. By providing the nacreous image with a pressure sensitive adhesive, the tough, durable nacreous image can be applied to various surfaces, which is particularly desirable for the youth market.

Because the nacreous polyester sheet of the invention contains voids that have much higher length to height ratio compared to organic voided prior art nacreous materials, the invention materials have a very high degree of opalescence or nacreous look and therefore have broader consumer appeal. Further, because the invention voiding process more efficiently voids polymer compared to prior art organic particle voiding, the invention materials are of a lower density and thus weigh less than prior art materials. The polyester materials in the invention have been shown to be more stable to UV energy and polymer chain fracturing compared to prior art polyolefin nacreous material allowing the polyester materials of the invention to have a improved mechanical half life.

The nacreous appearance of the image can be created utilizing a variety of imaging techniques. In addition to silver halide images, ink jet images, thermal dye transfer images, and electrophotographic images all have the nacreous appearance when the images are applied to the nacreous support. These and other advantages will be apparent from the detailed description below.

The terms as used herein, “top”, “upper”, “emulsion side”, and “face” mean the side or toward the side of a photographic member bearing the imaging layers. The terms “bottom”, “lower side”, and “back” mean the side or toward the side of the photographic member opposite from the side bearing the photosensitive imaging layers or developed image. Nacreous appearance is a pearly, luster, iridescent, metallic sheen. A characteristic property of a nacreous appearance is an angular dependence of viewing angle.

For the imaging element of the invention, imaging layers are applied to the upper side of the nacreous base. The imaging element contains a voided polymer layer on the lower side of the imaging layers. The layers above the voided layer and below the imaging layers are substantially free of white pigments that have been shown to corrupt the dye hue inks, pigments or dyes used to form an image. White reflecting layers comprising polymer layers below (on the lower side of) the voided layer do contain white, reflecting pigments, which have been shown to significantly improve sharpness, whiteness and photographic printing speed compared to prior art materials. These white reflective layers should be between 20 and 50 micrometers thick. Surprisingly, it has been found that when the voided polymer sheets of the invention, when applied to a cellulose paper core, provide photographic image sharpness, and printing speed comparable to prior art coextruded support materials that contain white pigments just below the imaging layers.

The preferred white pigment in polymer layers below the voided layer comprises TiO₂. TiO₂ is preferred because of it has a high refractive index which is important in adding opacity to the imaging member as well as maintaining sharpness by reducing the amount of exposure light entering the highly scattering cellulose paper base. The white pigment-containing layer may have at least 0.10 grams/cc of TiO₂. Below 0.10 g/cc there is a sufficiently low amount of TiO₂ that the photographic sharpness and speed are not adequately improved. The imaging member of this invention may have a layer of white pigment selected from one of the group comprising of TiO₂, BaSO₄, clay, talc, kaolin, and ZnS. The preferred spectral transmission of the white pigmented layer below the voided layer is less than 22%. Spectral transmission is the ratio of the transmitted power to the incident power and is expressed as a percentage as follows; T_{RGB}=10^{-D}*100 where D is the average of the red, green and blue Status A transmission density response measured by an X-Rite model 310 (or comparable) photographic transmission

According to the present invention a method for the production of a nacreous polyester sheet comprises forming a blend of particles of a linear polyester with from 10 to 45% by volume (based on the total volume of the blend) of particles of an incompatible polymer. Said incompatible polymer preferably being homopolymer or copolymer of polyolefin, extruding the blend as a film, quenching and biaxially orienting the film by stretching it in mutually perpendicular directions, and heat setting the film.

The nacreous appearance of the resulting film or sheet arises through voiding which occurs between the regions of the linear polyester and the polyolefin polymer during the stretching operation. Said polyester forms a matrix encompassing the voids. The index of refraction difference of the polyester polymer and the gas in the voids formed is between 0.2 and 0.8. Preferably the difference in refractive index is between 0.45 and 0.65. The linear polyester component of the film may consist of any thermoplastic film forming polyester which may be produced by condensing one or more dicarboxylic acids or a lower alkyl diester thereof, e.g. terephthalic acid, isophthalic, phthalic, 2,5-, 2,6- or 2,7-naphthalene dicarboxylic acid, succinic acid, sebacic acid, adipic acid, azelaic acid, bibenzoic acid, and hexahydroterephthalic acid, or bis-p-carboxy phenoxy ethane, with one or more glycols, e.g. ethylene glycol, 1,3-propanediol, 1-4-butanediol, neopentyl glycol and 1,4-cyclohexanedimethanol. It is to be understood that a copolymers of polyester materials may also be used. Suitable polyesters are polyethylene terephthalate, polyethylene naphthalate and poly(1,4-cyclohexylene dimethyhlene terephthalate). The preferred polyester is polyethylene terephthalate.

The preferred polyolefin additives which are blended with the polyester are a homopolymers or copolymers of polypropylene or low density polyethylene. An amount of 10 to 45% by volume (based on the total volume of the blend) of polyolefin additive is used. Amounts less than 10% by volume do not produce an adequate nacreous appearance. Increasing the amount of polyolefin additive causes the tensile properties, such as tensile yield and break strength, modulus and elongation to break, to deteriorate and it has been found that amounts generally exceeding about 45% by volume can lead to film splitting during production. Optimal nacreous appearance and tensile properties can be obtained with between 20 and 35% by volume of polyolefin additive.

The polyolefin additive used according to this invention is incompatible with the polyester component of the film and exists in the form of discrete globules dispersed throughout the oriented and heat set film. The nacreous appearance of the film is produced by voiding which occurs between the additive globules and the polyester when the film is stretched. It has been discovered that the polymeric additive should be blended with the linear polyester prior to extrusion through the film forming die by a process which results in a loosely blended mixture and does not develop an intimate bond between the polyester and the polyolefin additive.

Such a blending operation preserves the incompatibility of the components and leads to voiding when the film is stretched. A process of dry blending the polyester and polyolefin additive has been found to be useful. For instance, blending may be accomplished by mixing finely divided, e.g. powdered or granular, polyester and polymeric additive and, thoroughly mixing them together, e.g. by tumbling them. The resulting mixture is then fed to the film forming extruder. Blended polyester and polymeric additive which has been extruded and, e.g. reduced to a granulated form, can be successfully re-extruded into a nacreous voided film. It is thus possible to re-feed scrap film, e.g. as edge trimmings, through the process. Alternatively, blending may be effected by combining melt streams of polyester and the polyolefin additive just prior to extrusion. If the polymeric additive is added to the polymerization vessel in which the linear polyester is produced, it has been found that voiding and hence nacreous appearance is not developed during stretching. This is thought to be on account of some form of chemical or physical bonding which may arise between the additive and polyester during thermal processing.

The extrusion, quenching and stretching of the film may be effected by any process which is known in the art for producing oriented polyester film, e.g. by a flat film process or a bubble or tubular process. The flat film process is preferred for making film according to this invention and involves extruding the blend through a slit die and rapidly quenching the extruded web upon a chilled casting drum so that the polyester component of the film is quenched into the amorphous state. The quenched film is then biaxially oriented by stretching in mutually perpendicular directions at a temperature above the glass-rubber transition temperature of the polyester. Generally the film is stretched in one direction first and then in the second direction although stretching may be effected in both directions simultaneously if desired. In a typical process the film is stretched firstly in the direction of extrusion over a set of rotating rollers or between two pairs of nip rollers and is then stretched in the direction transverse thereto by means of a tenter apparatus. The film may be stretched in each direction to 2.5 to 4.5 times its original dimension in the direction of stretching. The ratio of the stretching in each direction is preferably such as to form voids in the sheet with a width to length ratio of between 1:1 and 2:1. After the film has been stretched it is heat set by heating to a temperature sufficient to crystallize the polyester whilst restraining the film against retraction in both directions of stretching. The voiding tends to collapse as the heat setting temperature is increased and the degree of collapse increases as the temperature increases. Hence the nacreous appearance decreases with an increase in heat setting temperatures. Whilst heat setting temperatures up to about 230 C. can be used without destroying the voids, temperatures below 155 C. generally result in a greater degree of voiding and higher nacreous appearance.

The nacreous appearance was determined by the FLOP measurement. FLOP is a measurement based on Lightness or L* in CIE coordinates measured at different angles from a vector normal to a materials surface. FLOP values are determined by an empirically derived formula relating these L* values to the degree of opalescence of a material.

$$FLOP = \frac{15 ( {L1}^{*} - {L3}^{*} )}{{{L2}^{*} }^{0.86}}$$

WHERE: Incident light is exposed to the surface at 45 degrees from normal

L1*=L* at an angle 35 degrees from normal

L2*=L* at an angle 0 degrees from normal

L3*=L* at an angle −65 degrees from normal.

The FLOP measurement of a film depends upon the length of the voids formed in the film, the length to height ratio of the voids, and the number of voids in the vertical direction of the film. The length of the voids should be greater than 5 um and the length to height ratio is greater than 9:1. Thus the stretched and heat set films made according to this invention have a FLOP measurement in excess of 45%, preferably exceeding 70%.

The invention also therefore relates to nacreous biaxially oriented and heat set films produced from a blend of a linear polyester and from 10 to 45% by volume (based on the total volume of the blend) of a homopolymer or copolymer of polypropylene or low density polyethylene and having a FLOP measurement of between 45% and 100%. Preferably the FLOP is between 70% and 100%. Such films may be made by the process specified above. The globules of polymeric additive distributed throughout the film produced according to this invention are elongated with a length to height ratio from 3 to 10 with the voids surrounding the globules having length to height ratio of greater than 9. Preferably the length to height ratio is between 10 and 100. The length of such voids can be between 5 and 100 micrometers and are preferably between 5 and 50 micrometers. It has been found that the voiding tends to collapse when the void size is of the order of the sheet thickness. Such sheets therefore tend to exhibit low nacreous appearance because of the smaller number of void surfaces at which light scattering can occur. Accordingly it is therefore preferred that the nacreous sheets of this invention should have a thickness such as to comprise at least 6 voids as measured in the vertical direction and measure between 5 and 70 micrometers. Preferably the sheets will have between 10 and 25 voids in the vertical direction and a thickness between 20 and 50 micrometers.

The roughness average of such sheets is generally less than 0.4 um. Because of the voiding, the sheets are less dense, i.e. lighter in weight, and more resilient than non-voided sheets. The density of the sheets of this invention is in the range 0.6 to 1.30. The sheets may be used in any of the applications for which a nacreous appearance is desired, except of course those where a high degree of transparency is required.

The sheets of this invention are suitable as a base for an imaging member, i.e. as a substitute for an imaging member such as photographic prints. The invention therefore also relates to an imaging member. Said imaging member comprising a support in the form of a nacreous biaxially oriented and heat set sheet formed from a blend of a linear polyester and from 10 to 45% by volume (based on the total volume of the blend) of a homopolymer or copolymer of polyethylene or polypropylene having a FLOP in excess of 45%, said member carrying a photosensitive layer. The support is preferably made from blends containing between 20% and 35% by volume of the polyolefin additive.

Imaging members generally further comprise an imaging layer. Such imaging layer requiring adhesion to the imaging member. In the case of a photosensitive imaging member adhesion of a photosensitive layer is required. Conveniently the photosensitive layer is a silver halide-containing gelatinous layer. The photosensitive layer may be applied directly to the surface of the nacreous support but preferably one or more intermediate layers are provided to enhance the adhesion of the photosensitive layer to the sheet surface. The intermediate layer(s) may be applied by any suitable method known for the application of coatings to polyester sheet surfaces. Generally, a polymeric subbing layer, such as vinylidene chloride copolymer which may be applied to the film surface from an aqueous dispersion during the film production (e.g. between the two stretching operations) or after the film has been made, may be applied directly to the surface of the film and a gelatinous subbing layer applied over the polymeric layer. Alternatively, plasma treating the surface of the nacreous sheet of such an imaging member results in adequate adhesion of the photosensitive layer. An integral binder layer for said image layer adhesion which could alternatively be coextruded on one surface of the nacreous sheet of said imaging member.

The nacreous sheet of said imaging member could be laminated to a support sheet. This support sheet's thickness should be 125 and 300 um to provide stiffness of the imaging member of between 100 and 250 milli-newtons. This aids in conveyance and the imaging member and gives the imaging member a pleasing feel.

Said support sheet could be paper. Said support sheet may have a white reflective layer beneath the voided nacreous sheet to reflect light back through said sheet further enhancing the nacreous appearance. The white reflective layer should be in the range of 25 to 50 micrometers. Typically said white reflective layer would comprise titanium dioxide or other pigments. Typically said imaging member would comprise a support sheet comprising both a white reflective layer and a paper support sheet.

Also an antistatic layer can be formed adjacent to the support sheet to improve conveyance and coatability of the imaging member. This antistatic layer can be coated or integrally formed in a coextrusion or lamination process.

Also the imaging member could comprise an integral layer on the bottom of said nacreous sheet which has a writable surface. This is a desirable attribute of most imaging members.

Imaging members comprising said nacreous polyester sheet offer a pleasing appearance that is desirable for applications such as advertisement and portraits.

### EXAMPLES

### Preparation of Nacreous Polyester Sheets

### Example 1

Polyethylene terephthalate (PET)(#7352 from Eastman Chemicals) was dry blended with low density Polyethylene (“LDPE”, 1810E, Eastman Chemicals) at 40% by volume (based on the total volume of the blend) and dried in a desiccant dryer at 65° C. for 12 hours.

PET (#7352 from Eastman Chemicals) was dry blended with a TiO2 in PET masterbatch (#9663E002 from Eastman Chemicals which comprises 50% by weight of TiO2 and 50% wt of PET) at 25% by volume (based on the total volume of the blend) and dried in a desiccant dryer at 65° C. for 12 hours.

Cast sheets were co-extruded in an A/B layer structure using a 2½″ extruder to extrude the PET/LDPE blend, layer (A), and a 1″ extruder to extrude the TiO2/PET blend, layer (B). The 275° C. melt streams were fed into a 7 inch multi-manifold die also heated at 275° C. As the extruded sheet emerged from the die, it was cast onto a quenching roll set at 55° C. The final dimensions of the continuous cast sheet were 18 cm wide and 480 um's thick. Layer (A) was 120 um's thick while layer (B) was 360 um's thick. The cast sheet was then stretched at 110° C. first 3.0 times in the X-direction (machine direction) and then 3.4 times in the Y-direction (cross machine direction). The stretched sheet was then Heat Set at 150° C.

### Example 2

Another sample was formed as in Example 1 except the material used in layer (A) was replaced with PET (#7352 from Eastman Chemicals) dry blended with Polypropylene (“PP”, Huntsman P4G2Z-073AX) at 25% volume (based on the total volume of the blend).

### Example 3

Another sample was formed as in Example 1 except the material used in layer (A) was replaced with PET (#7352 from Eastman Chemicals) dry blended with a different Polypropylene (“COP PP”, Montell 6433) at 35% volume (based on the total volume of the blend).

### Comparative 1

A composite 5 layer biaxially oriented polyolefin sheet (38 micrometers thick) (d=0.75 g/cc), as is disclosed in U.S. Pat. No. 6,274,284, consisting of a microvoided and oriented polypropylene (PP) core layer 24 um thick. This core layer is functionally the same as layer A as described in Example 1. The PP of this layer contains poly(butylene terephthalate), PBT, as a voiding agent. There are two clear polyolefin layers on top of the core layer, a clear PP layer adjacent to the core layer, 5.5 um thick, and a clear polyethylene layer, 0.8 um thick, on top of said PP layer.

There are also two layers under the core layer both of which are PP. The bottom layer adjacent to said core layer is a PP matrix with 18% TiO2 by weight (based on the total weight of the layer) and is 7.0 um thick. This layer is functionally the same as layer B of Example 1. The bottom most PP layer is a clear PP and is 0.8 um thick.

### Comparative 2

A Leistritz 27 mm Twin Screw Compounding Extruder heated to 275° C. was used to mix PET (#7352 from Eastman Chemicals) and Polypropylene (“PP”, Huntsman P4G2Z-073AX). The polypropylene was added at 35% volume (based on the total volume of the mixture).

All components were metered into the compounder and one pass was sufficient for dispersion of the PP into the polyester matrix. The compounded material was extruded through a strand die, cooled in a water bath, and pelletized. The pellets were then dried in a desiccant dryer at 65° C. for 12 hours.

Then PET (#7352 from Eastman Chemicals) was dry blended with a TiO2 in PET masterbatch (#9663E002 from Eastman Chemicals which comprises 50% by weight of TiO2 and 50% wt of PET) at 25% by volume (based on the total volume of the blend) and dried in a desiccant dryer at 65° C. for 12 hours.

Cast sheets were co-extruded in an A/B layer structure using a 2½″ extruder to extrude the PET/PP mixture, layer (A) and a 1″ extruder to extrude the TiO2/PET blend, layer (B). The 275° C. meltstreams were fed into a 7 inch multi-manifold die also heated at 275° C. As the extruded sheet emerged from the die, it was cast onto a quenching roll set at 55° C. The final dimensions of the continuous cast sheet were 18 cm wide and 480 um's thick. Layer (A) was 120 um's thick while layer (B) was 360 um's thick. The cast sheet was then stretched at 110° C. first 3.0 times in the X-direction and then 3.4 times in the Y-direction. The stretched sheet was then Heat Set at 150° C. Comparative 3 Another comparative sample was formed as in Comparative 2 except the PP added at 35% volume to PET in layer (A) was replaced with 2 um microbeads of Polystyrene crosslinked 30% with divinylbenzene. These microbeads were added into the PET at 25% volume (based on the total volume of the mixture).

Table 1 summarizes the thickness of the two functional layers, layers A and B, as well as a description of the void initiators and their degree of loading in the matrix polymer of layer A for each sample.

Each of the above samples were laminated to a 175 um thick photographic grade paper support with the voided layer, layer (A), on top. Each of these laminated members were tested for FLOP measurement as described previously. The void length of layer (A) of each member was measured by cross sectioning and imaging the cross section using a scanning electron microscope. In the same manner the length to height ratio and the width to length ratio were measured, as well as the number of voids in the vertical direction. Table 2 shows all measurements of the members.

The void length and the width to length ratios are all very close to the same for all Examples 1 thru 3 and Comparatives 1 thru 3.

It can be seen from the data in Table 2 that the incompatible dry blends of layer (A) in each of the Examples 1 thru 3 result in a length to height ratio of 10 or greater. The sample of comparative 1 had a lower length to height ratio, 8, and also had a low number of voids in the vertical direction, 5, as compared to a range of 13 to 20 for example 1 thru 3. The sample of Comparative 2 which was compounded in a twin screw extruder (as opposed to dry blending) and used the same polypropylene as Example 2(dry blended) had an even lower length to height ratio, 7. Further the sample of Comparative 3 which used a non-polyolefin, cross linked polystyrene, as a void initiator in the polyester matrix of layer (A) resulted in a length to height ratio of only 3.3. Furthermore, it can be seen in Table 2 that the FLOP measurement is strongly related to the length to height ratio of the samples. Each of the members formed by laminating Examples 1 thru 3 to 175 um paper were subsequently coated with a photographic emulsion. These members were photographically exposed and processed. The resulting images were very nacreous in appearance.

TABLE 1

| | | Void Initiator A | Layer B |
|---|---|---|---|
| | Layer A | Vol. Load/Material | Material/Thick. |
| SAMPLE | Matrix/Thick. | (size if particulate) | Wt %/um |
| Example 1 | PET/20 um | 40%/1810 LDPE | 92% PET & 8% TiO2/36 um |
| Example 2 | PET/24 um | 25%/Huntsman PP | 92% PET % 8% TiO2/36 um |
| Example 3 | PET/28 um | 35%/6433 PP | 92% PET % 8% TiO2/36 um |
| Comparative 1 | PP/24 um | 5%/PBT (5 um) | 82% PP & 18% TiO2/7 um |
| Comparative 2 | PET/28 um | 35%/Huntsman PP | 92% PET % 8% TiO2/36 um |
| Comparative 3 | PET/22 um | 25%/X-linked PS (2 um) | 92% PET % 8% TiO2/36 um |

TABLE 2

| | | Length/ | Width/ | | |
|---|---|---|---|---|---|
| | Void Length | Height | Length | # Voids | |
| SAMPLE | Layer A | Ratio | Ratio | Vertically | FLOP |
| Example 1 | 10.0 um | 40 | 1.25 | 16 | 72 |
| Example 2 | 40.0 um | 41 | 1.25 | 13 | 78 |
| Example 3 | 8.0 um | 10 | 1 | 20 | 46 |
| Comparative 1 | 40.0 um | 8 | 1.5 | 5 | 41 |
| Comparative 2 | 25.0 um | 7 | 1 | 29 | 24 |
| Comparative 3 | 6.6 um | 3.3 | 1 | 14 | 17 |

The invention has been described in detail with particular reference to certain preferred embodiments thereof, but it will be understood that variations and modifications can be effected within the spirit and scope of the invention.

What is claimed is:

1. A nacreous polymer sheet comprising voided polyester polymer wherein said sheet has voids of a length to height ratio of greater than 9:1, voids of a length of between 5 and 100 micrometer and a number of voids in the vertical direction of greater than 6.

2. The polymer sheet of claim 1 wherein said voids have a width to length ratio in the plane of the sheet of between 1:1 and 2:1.

3. The polymer sheet of claim 1 wherein said voids have a length to height ratio of between 10:1 and 100:1.

4. The polymer sheet of claim 1 wherein said voids have a length of between 5 and 50 micrometers.

5. The polymer sheet of claim 1 wherein the thickness of the sheet is between 5 and 70 micrometers.

6. The polymer sheet of claim 1 wherein the thickness of the sheet is between 20 and 50 micrometers.

7. The polymer sheet of claim 1 wherein the number of voids in the vertical direction is between 10 and 25.

8. The polymer sheet of claim 1 wherein the refractive index difference of the polyester polymer and the gas in the voids is between 0.2 and 0.8.

9. The polymer sheet of claim 1 wherein the refractive index difference of the polyester polymer the gas in the voids is between 0.45 to 0.65.

10. The polymer sheet of claim 1 wherein said polyester is selected from the group consisting of polyethylene terephthalate, polyethylene naphthalate and poly(1,4-cyclohexylene dimethyhlene terephthalate).

11. The polymer sheet of claim 1 wherein said polyester comprises polyethylene terephthalate.

12. The polymer sheet of claim 1 wherein said polyester comprises polyethylene terephthalate copolymers.

13. The polymer sheet of claim 1 wherein said polymer sheet further comprises polyolefin.

14. The polymer sheet of claim 1 wherein said polymer sheet further comprises a polymer incompatible with polyester.

15. The polymer sheet of claim 13 wherein said polyolefin comprises polyethylene or polypropylene.

16. The polymer sheet of claim 1 wherein said polymer sheet has a FLOP value of between 45 and 100.

17. The polymer sheet of claim 1 wherein said polymer sheet has a FLOP value of between 70 to 100.

18. The polymer sheet of claim 1 wherein said polyester forms a matrix encompassing the voids.

19. The polymer sheet of claim 1 wherein said sheet has a roughness average of less than 0.4 micrometers.

20. The polymer sheet of claim 13 where in between 10% and 45% by volume of the sheet is polyolefin.

21. The polymer sheet of claim 13 where in between 20% and 35% by volume of the sheet is polyolefin.

22. An imaging member comprising a nacreous polymer sheet comprising at least one layer of voided polyester polymer wherein said at least one layer has voids of a length to height ratio of greater than 9:1, voids of a length of between 5 and 100 micrometer and a number of voids in the vertical direction of greater than 6.

23. The imaging member of claim 22 comprising an integral binder layer for said image layer.

24. The imaging member of claim 22 further comprising a white reflective layer beneath said voided polyester polymer layer.

25. The imaging member of claim 24 wherein said white reflective layer comprises titanium dioxide.

26. The imaging member of claim 24 wherein said white reflective layer is between 20 and 50 micrometers thick.

27. The imaging member of claim 22 wherein said nacreous sheet is laminated to a support member.

28. The imaging member of claim 27 wherein said image layer comprises at least one layer of photosensitive silver halide.

29. The imaging member of claim 27 wherein said support member comprises paper.

30. The imaging member of claim 27 wherein said support member has a thickness of between 125 and 300 micrometers.

31. The imaging member of claim 30 wherein said imaging member has a stiffness of between 100 and 250 millinewtons.

32. The imaging member of claim 30 wherein said support member further comprises a white reflective layer between 20 and 50 micrometers thick.

33. The imaging member of claim 31 wherein said imaging member further comprises an antistatic layer.

34. The imaging member of claim 31 wherein said imaging member further comprises an integral antistatic layer.

35. The imaging member of claim 22 further comprising an integral layer on the bottom of said nacreous polymer sheet that has a writable surface.

36. A method for the production of a nacreous polymer sheet comprising voided polyester polymer wherein said sheet has voids of a length to height ratio of greater than 9:1, voids of a length of between 5 and 100 micrometer and a number of voids in the vertical direction of greater than 6, comprising forming a blend of particles of a linear polyester with from 10 to 45% (based on total blend volume) of particles of a homopolymer or copolymer of polyolefin, extruding the blend as a film, quenching and biaxially orienting the film by stretching it in mutually perpendicular directions, and heat setting the film.
